(19) United States
(12) Patent Application Publication
(10) Pub. No.: US 2012/0111504 A1
(43) Pub. Date: May 10, 2012

(54) METHOD AND APPARATUS FOR MANUFACTURE OF REINFORCED MEMBRANE ENCASED CABLE MATERIAL

(76) Inventor: Henry L. Hamlin, III, Macon, GA (US)

(21) Appl. No.: 13/225,304

(22) Filed: Sep. 2, 2011

Related U.S. Application Data
(60) Provisional application No. 61/379,597, filed on Sep. 2, 2010.

(51) Int. Cl. B32B 37/06

(52) U.S. Cl. 156/383

(57) ABSTRACT

A method and apparatus for manufacture of encased cable material includes a frame for supporting spools of membrane strips and cable, a guide system, a welding assembly, and welding rollers. The membrane strips arranged with an upper membrane strip and lower membrane strip in coplanar relation with a cable position for being fed between the strips. The membrane strips and cable are continuously fed from spools by pulling them past a heating element of the welding assembly to prepare the membrane strips coplanar surfaces for bonding, and the welding rollers press the membrane strips together to bond the surfaces and encase the cable by welding membrane strips together.

### PRIORITY CLAIM

The present application claims benefit of U.S. Provisional Patent Application No. 61/379,597 filed on Sep. 2, 2010.

### BACKGROUND OF THE INVENTION

The present invention relates to preparation of reinforced cable for installation of thermoplastic roofing membranes, and, particularly, to a method and apparatus to create a cable seam encased in thermoplastic membrane material for installation of roofing membrane.

It is known to apply thermoplastic membranes to roof tops to prevent leakage of water through the roof. Typically, the membranes are sealed to each other along overlapping edges, and the membrane is attached to the roof deck by mechanical means or adhesive. It has been discovered in related applications that using a system of cables or reinforced cable-like elongate cord members for installation of roofing membrane has advantages over prior art glue, asphalt or mechanical screws. In an embodiment of the cable system for installation of the membrane, it is beneficial to cover the cable in welded membrane strips to seal the cable (i.e. cable, cord or high-strength elongate member) to provide a finished appearance, protect against nature's elements, and prevent roof leaks. The sealed cable and welded membrane strips provide an encased cable material that may be attached to the roof substrate by mechanical means or welded to underlying membrane via the bottom cable covering membrane strip to attach the cable to the roof and retain the underlying membrane substrate securely.

In the manual method for covering the cable with membrane, a strip of membrane material must be cut for laying over the cable. The cable is laid across the roof, and then the strip of membrane is laid on top of the cable across the roof in the desired location. The strip of membrane is then heated to weld the strip to the underlying membrane roofing and encase the cable within the membrane. An advantage of the cable system for installation of roofing membrane is a reduction of time and efficiency. However, the manual process for laying out a cable and welding a strip of membrane to cover the cable is still time consuming because of the multiple steps required and needs further improvement.

Accordingly, there is a need for eliminating the step of covering and encasing the cable during installation on the roof membrane substrate. A process for encasing the cable prior to installation is needed so that cable can be installed on membrane roofing in a minimal number of steps in lieu of using traditional mechanical or adhesive means to secure membrane roofing.

### SUMMARY OF THE INVENTION

The invention provides a method and apparatus for continuous manufacture of encased cable material. Spools of thermoplastic membrane strip material are provided and arranged for feeding into a heat welding arrangement. A spool of cable is provided and arranged for insertion of the cable between membrane strips of material. The membrane strips of material are bonded to one another with the cable compressed between the elongate centers of the strips. The membrane strips and cable are layered as they are fed from the spools through a system of guides and fed forward for heating. After heating the membrane strips on each side of the cable. The membrane strips and cable are fed continuously into welding rollers that compress the edges of the membrane strips on each side of the cable together, whereby the membrane strips are welded together with the cable between the strips. An electric motor drives one of the welding rollers to feed the membrane strips and cable from the spools though the apparatus.

An object of the present invention provides a method to manufacture encased cable material for installation of roofing membrane.

Another object of the invention is to manufacture encased cable material continuously for subsequent use.

Yet another object of the invention is to eliminate the need to cover cable with membrane material to create a membrane seam over the cable during installing of roofing membrane using a cable installation system.

### BRIEF DESCRIPTION OF THE DRAWINGS

FIG. 1 is a plan view of a method and apparatus for manufacture of reinforced membrane encased cable in accordance with an embodiment of the invention.

FIG. 2 is a cut-away sectional end view of a reinforced membrane encased cable in accordance with the invention.

### DETAILED DESCRIPTION OF THE INVENTION

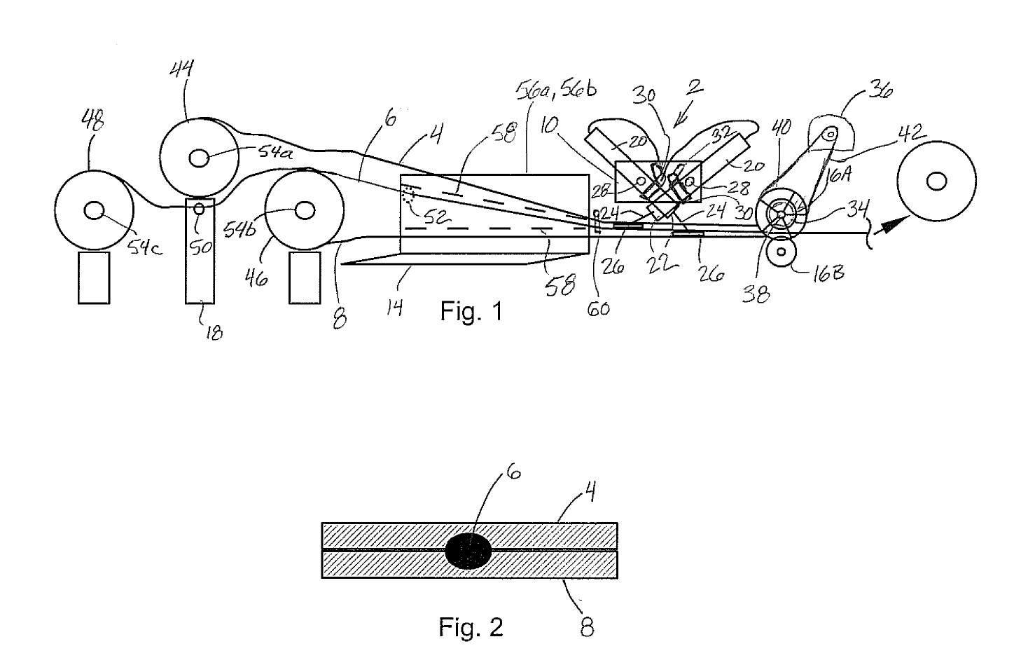

Referring to FIG. 1, an apparatus welding assembly 2 is shown for welding thermoplastic membrane strips and encasing at least one cord of cable 6 or high strength elongate material within the membrane strips. The welding assembly 2 is mounted in a welding position with an upper thermoplastic membrane strip 4, an intermediate cable/cord 6 of suitable cable material, and a lower thermoplastic membrane strip 8, said thermoplastic strips to be welded together. Welding assembly 2 is provided with a mounting frame 10 for supporting the assembly of components and supply of upper membrane strip 4 and lower membrane strip 8 (i.e. membrane materials) and supply of cable 6 (i.e. cable material). The frame supports motor drive system 12, a guide system including a stand 14, welding rollers 16, a spool stand 18 supporting several material supply spools, and a heating apparatus comprising heat welding tools 20 with first and second heating elements 22.

The welding assembly 2 is preferably equipped with a pair of heat welding tools 20 for heating thermoplastic membrane strips so that they can be welded together. In order to ensure good contact for uniform heating between the welding nozzles 26 of the heat welding tools 20 and the thermoplastic strips to be welded together, a guide system is provided on the apparatus. The guide system includes a guide stand 14 that is mounted with a guide for the cable 6 and guides, consisting of upper guide plate and lower guide plate, for the upper membrane strip 4 and lower membrane strip 8. The guide system guides the coplanar upper membrane strip and lower membrane strip to be received for heating by the first and second heating elements of the welding tools with the cable material situated in coplanar relationship between the membrane strips.

Each of the heat welding tools 20 comprises a hot air blower 24 and welding nozzle 26. The tools 20 are held by a tool holder 30 supporting the hot air blower 24 portion of the tools, and the position of the tools may be optionally locked by a locking device 28, such as a locking lever, set screw or clamp. The tool holder 30 may slide onto a horizontal arm 32 attached to the frame of the welding assembly 2, and the heat welding tool 20 may rotate and slide about the arm to position the respective heating nozzle 26 or retract the respective heating nozzle from the membrane strips 4, 8 or remove the heat welding tool from the welding assembly 2. In one embodiment the heat welding tools 20 comprise a roofing membrane welder used for overlap welding of roofing membranes made of PVC, PE, ECB, EPDM, CSPE and Modified Bitumen, and commonly used for areas close to edges and uneven surfaces or overlap welding of foils and coating materials.

The heating nozzles 26 are located behind (in travel direction of device) the guide stand 14 where the material being welded is inserted through the guide stand 14 and exits the guide stand to the heating nozzles 26. The heating nozzles 26 may be retractable to be removed from the welding device or to insert and remove the heating nozzles 26 from the thermoplastic membrane strips. The heating nozzles 26 provide a pair of heating elements 22 comprising a first heating element and a second heating element that insert between the membrane strips with an element inserted from each side of the cable 6. These heat nozzles 26 may be independently operated via the associated heat welding tool 20. The heat nozzles 26 are situated immediately before the location of the welding rollers 16 to heat the membrane strips 4, 8 immediately before entering the welding rollers 16 so that a bond forms at the hot surfaces of the membrane strips as they are brought together into contact by the welding rollers 16. The heat nozzles 26 are double-sided so that each nozzle heats both the bottom surface of the upper membrane strip 4 and top surface of the lower membrane strip 8. Thereby, the heating elements are arranged to heat the facing and opposing surfaces of the upper membrane strip and the lower membrane strip in preparation for receipt of the membrane strips by welding rollers.

A welding roller section of the device is provided with at least one upper welding roller 16A. Said upper welding roller 16A is mounted on a bracket and axis associated with the mounting frame 10, so that the roller can rotate around the axis. The upper welding roller 16A may be fixed in a vertical position, or provided an adjustable compression spring attached to the roller axis that tends to continuously press the upper welding roller uniformly against the upper surface of the upper thermoplastic membrane strip 4. The distance between the welding rollers 16 may vary depending on the thickness of the membrane strips 4, 8 and cable 6 fed through the system. Such distance may be predetermined and fixed by design or variable using fixed adjustable positions or by using compression springs in cooperation with the welding rollers 16.

The welding roller section is further provided with at least one lower welding roller 16B that is located directly below the upper welding roller 16A. The upper and lower welding rollers 16A, 16B each include a notch 34 near the center of each roller surface. These notches 34 align to form a channel between the welding rollers 16 for receiving the cable 6 as it is fed through the rollers. Thereby, the rollers do not bind because of pressure on the cable 6 and suitable pressure for bonding may be applied to the coplanar membrane strips 4, 8 passing through the welding rollers 16. Said lower welding roller 16B is mounted on a bracket and axis associated with the mounting frame 10 so that the lower roller can rotate around the axis. Another adjustable compression spring may be attached to the lower roller axis to continuously press the lower welding roller uniformly against the lower surface of the lower thermoplastic membrane strip.

The upper or lower welding rollers 16 may be motor driven so that the membrane strips 4, 8 and cable 6 are pulled through the apparatus by the welding rollers 16. In the embodiment shown, the lower welding roller 16B freely rolls independent of the upper roller 16A, which rotates and is driven by an electric motor 36. Accordingly, the lower welding roller 16B rolls according to the pressure applied. The welding rollers 16 may include a specially prepared surface to ensure proper grip on the membrane strips during pulling, such as a knurled or tacky surface. Alternatively, the cable 6 and membrane strips 4, 8 may be pulled through the rollers by additional roller wheels or means for pulling and re-spooling the finished encased cable material. Said pulling and re-spooling means may include a manually operated reel or an external motor operated pulling system.

As shown, the upper welding roller 16A is driven by a rotating shaft 38 that is attached to a belt-driven drive wheel 40. A belt 42 connects the drive wheel 40 to the electric motor 36 operable by a switch to start the transfer of materials through the rotation of the upper welding roller 16A. In this embodiment, the upper welding roller 16A contacts the upper membrane strip 4 and compresses the upper membrane strip 4 against the lower membrane strip 8. The rotation of the upper welding roller 16A drives the upper membrane strip 4 through the apparatus, whereby the movement of the upper strip 4 also moves the lower strip 8 and the cable 6 through the apparatus.

Referring to the figures, a bonded seam is produced during welding of the two thermoplastic membrane strips by the welding rollers 16. The cable 6 is situated about the center of the bonded seam, and is affixed within the seam by the bond of the thermoplastic strips, while being provided within the seam as an unwelded member between the membrane strips. Thus, the bonded membrane strips provide a passage for the cable 6 as shown.

In the side view shown in the figures of a welding method as described, the guide stand 14 is mounted in the direction of the path of membrane strips 4, 8 and cable 6 coming from spools. The path includes a spool 44 of membrane strip for the upper membrane strip 4, a spool 46 of membrane strip for the lower membrane strip 8, and a spool 48 of cable 6 for insertion of cable 6 between the two membrane strips 4, 8. As shown in the preferred embodiment, the assembly of the apparatus provides for the spool of cable 48 at the beginning end of the assembly. The cable 6 feeds from the top of the spool 48 by the spool rolling clockwise. The cable 6 then runs below the spool 44 of upper membrane strip material that is positioned next in the line for the assembly of the apparatus. By running below the spool 44 of upper membrane strip 4, the cable 6 is positioned below the lower surface of the upper membrane strip 4 as the upper membrane strip feeds from the top of the spool 44 like the cable 6. A guide 50 may be provided below the spool 44 of upper membrane strip 4 to situate the cable 6 apart from the spool and guide the cable to the desired location between the strips. The cable 6 further runs above the spool 46 of lower membrane strip 8, which is positioned next in the line of the apparatus. This positions the cable 6 above the upper surface of the lower membrane strip 8. A second guide 52 may be provided to position the cable 6 in relation to the membrane strips 4, 8 and separate the cable from the lower membrane strip 8. Each of the spools is supported by a stand 18 and a spindle shaft 54a, 54b, 54c for rotating to feed the relative membrane strip or cable 6. The spools may be supported together on one composite stand structure, and the spools may be stacked vertically to reduce the length of the apparatus, aligned horizontally using guides to arrange the strips and cable 6 into layered relationship, or aligned longitudinally or staggered as shown.

The guide stand 14 includes a pair of opposing side walls 56a, 56b that are spatially separated to laterally position the membrane strips 4, 8 and provide structural support as a portion of the stand. One or more guide plates 58, including in the preferred embodiment an upper guide plate and a lower guide plate as shown, are situated between the opposing side walls 56a, 56b to guide the passage of the membrane strips 4, 8. The opposing pair of guide plates 58 may be angled toward the position of entry for the heating nozzles 26. The upper and lower plates may comprise flat panels the width of the distance between the side walls and provide a smooth surface for the membrane strips to move along. At the end of the plates 58 exiting the guide stand 14 in the direction of flow, a pair of horizontal rollers or rails is arranged on the frame to receive the layered strips and cable 6 in a coplanar stack and form an in-feed guide 60 to the heating nozzles 26. Thereby, the membrane strips 4, 8 pass along the heating nozzles 26 in close proximity or contact thereto.

The heating tools 20 are expected to be kept operationally ready by a temperature control means (not specifically shown) when manufacturing encased cable material. The surface bonding preparation process begins immediately after the heating nozzles 26 are applied to the membrane strips 4, 8 in the manner described above. By operating a switch on welding assembly 2, the electric motor 36 is actuated. This causes the upper welding roller 16A to begin moving, and the process of preparing the membrane strips and pressing them together takes place continuously.

It is also contemplated by the invention to have embodiments accommodating replacing of the welding rollers 16 to produce a singular weld, wider if required, without a plurality of welds. Accordingly, the heating nozzles 26 can be replaced by a singular heating unit.

While I have shown and described various embodiments in accordance with the present invention, it is understood that the same is not limited thereto but is susceptible of numerous changes and modifications as known to those skilled in the art and I therefore do not wish to be limited to the details shown and described herein but intend to cover all such changes and modifications as are encompassed by the scope of the appended claims.

I claim:

1. An apparatus for manufacture of encased cable material comprising:
a guide system receiving a supply of an upper membrane strip, a supply of a lower membrane strip, and a supply of a cable material;
a welding assembly including a first heating element and a second heating element arranged for receiving from the supply of each, the upper membrane strip in coplanar relation to the lower membrane strip with the cable material fed between the coplanar strips, and said heating elements arranged to heat facing and opposing surfaces of the upper membrane strip and the lower membrane strip; and
an upper welding roller and a lower welding roller arranged to receive and press the upper membrane strip to the lower membrane strip, whereby the upper membrane strip and the lower membrane strip bond and encase the cable material.
